(19) United States
(12) Patent Application Publication
(10) Pub. No.: US 2018/0162993 A1
(43) Pub. Date: Jun. 14, 2018

(54) METHODS AND COMPOSITIONS FOR PREPARING PARTICLE BOARDS

(71) Applicant: Rusi P. Taleyarkhan, Lafayette, IN (US)

(72) Inventor: Rusi P. Taleyarkhan, Lafayette, IN (US)

(21) Appl. No.: 15/575,441

(22) PCT Filed: May 13, 2016
(86) PCT No.: PCT/US16/32262

§ 371 Date: Nov. 20, 2017

Related U.S. Application Data
(60) Provisional application No. 62/163,420, filed on May 19, 2015.

(51) Int. Cl. C08G 63/06; C08G 63/78; C08J 3/03; C08J 3/12; C08J 3/28

(52) U.S. Cl. CPC C08G 63/06; C08G 63/78; C08J 3/03; C08L 97/02; C08J 3/28; C08J 2367/04; C08J 3/12

(57) ABSTRACT

An amorphous polylactic acid polymer having a weight average molecular weight of about 35,000 to 45,000 is described. The polylactic acid polymer composition can be of particles wherein 90% of the particles have a size of 250 nm or less, a glass transition temperature about 55 to 58 degrees centigrade, and a relative viscosity at 30 degrees centigrade between 1.65 to 1.95. The polymer composition can be used to form an aqueous suspension. The material is ideal in preparing particleboards. A method is disclosed for preparing such polylactic acid polymers. The method involves obtaining an amorphous polylactic acid polymer having a weight average molecular weight of between 115,000 to 180,000. Treating the polylactic acid polymer to reduce the molecular weight between 35,000 to 45,000 such that the glass transition temperature is about 55 to 58 degrees centigrade and a relative viscosity at 30 degrees centigrade about 1.65 to 1.95. 90% of the particles must have an average diameter of 250 nm or less.

### BACKGROUND

Natural adhesives such as animal glues, fish glues, vegetable glues and casein (the main protein in milk) are generally set upon solvent preparation and offer low strength and are susceptible to moisture and mold. Their use is mainly for joining low strength materials.

Elastomer adhesives such as natural rubbers, neoprene, acrylonitride budadiene, butyl/rubber adhesives, styrene butadiene rubber adhesives, polyurethane adhesives, polysulfide rubber adhesives, and silicone rubber adhesives are based on natural and synthetic rubbers set by solvent evaporation or heat curing; they have relatively low strength and suffer from creep and therefore are not usually used for stressed joints. More typically, they are used for flexible bonding of plastics and rubbers.

Thermoplastic adhesives such as polyvinyl acetate (PVA), polyvinyl alcohol (PVA), polyacrylates, polyester acrylics, acrylic solvent cement, cyanoacrylates (superglue), silicone resins, polyamides and acrylic acid diesters have low/medium strength and may suffer from creep and attack from water but not from oils.

Thermoset adhesives such as phenol formaldehyde (PF) resins, phenolic neoprene, polyesters, polyamides and epoxy resins set as a result of the buildup of rigid molecular chains with cross-linking.

Toughened rubber modified adhesives include small rubber-like particles dispersed throughout a glassy matrix are resistant to crack propagation and have been applied to acrylic and epoxy-based adhesives.

The general performance characteristics of these adhesives in terms of shear strength and range of operating temperatures are summarized in the table below.

TABLE 1
Properties of conventional adhesives

| | | | Operating temperature | |
|---|---|---|---|---|
| | Shear strength (MPa) | | (C.) | |
| Adhesive Type | Min. | Max. | Min. | Max. |
| Rubber | 0.35 | 3.5 | −20 | 150 |
| PVA (white glue) | 1.4 | 6.9 | | |
| Cyanoacrylate | 6.9 | 13.8 | | 80 |
| Anaerpbo | 6.9 | 13.8 | | 200 |
| Polyurethane | 6.9 | 17.2 | −200 | 150 |
| Rubber modified epoxy | 13.8 | 24.1 | −40 | 90 |
| Epoxy | 10.3 | 27.8 | | 200 |
| Polyamide | 13.8 | 27.6 | | 350 |
| Rubber modified epoxy | 20.7 | 41.4 | | 180 |

Note:
1 MPa = 10 bar about 147 psi; 1,000 psi = about 6.9 MPa

The strength of adhesives is dependent on how well the adhesive has bonded to the surface of a material (i.e., substrate), as well as on the cohesive strength of the adhesive itself. Virtually all of the listed compositions emit volatile organic compounds (VOCs) and they require set times ranging from tens of minutes to days, and the operating temperatures are generally below 150° C. to 200° C.

One area where novel adhesives are needed is in the area of particle manufacture. Examples of boards in use today include laminate flooring. Laminate flooring can be prepared by coating an adhesive onto wood particles or flours at high temperature, followed by molding and hot-pressing. Since the laminate flooring can be subjected to complicated machining and the like, the laminate flooring is widely used for interior finishing or overall furniture products. New adhesives are needed that can be used in the manufacture of particle boards.

Currently the adhesive used to make particle boards is mainly urea-formaldehyde resin or a melamine-urea-formaldehyde resin. These adhesives exhibit outstanding adhesion and are low-priced, the adhesive can irritate the eyes, nose and skin, as well as causing atopic diseases and bronchial asthma even after curing, and gradually emits formaldehyde, which can cause cancer when inhaled for a long time. In addition, excess melamine intake can result in formation of kidney stones in humans. Further, melamine, urea, formaldehyde and the like, which are prepared from fossil resources can be subject to price appreciation as fossil resources become depleted. Moreover, their production is associated with the emission large amounts of greenhouse gases and they consume a large amount of energy to prepare. Lastly, they are known to emit a variety of toxic substances such as endocrine disruptors, toxic gases and the like, when incinerated.

New adhesives are needed that have improved fatigue behavior and reduced stress concentration zones. They should be easy to use, allowing for high through put and have sealing capability such that the adhesive joint can seal joined materials from moisture and air. In addition, they should not melt or otherwise modify the substrates they are intended to join, they should be amenable to use in joining a broad range of substrates including aluminum substrates and they should be of minimal density.

### SUMMARY OF INVENTION

An amorphous polylactic acid polymer having a weight average molecular weight in the range of about 35,000 to 45,000 is described. The polylactic acid polymer composition can be in the form of particles wherein 90% of the particles have particle size of about 250 μm or less and the material has a glass transition temperature of between about 55° C. to about 58° C. and a relative viscosity at 30° C. is about 1.65 to about 1.95 centipoise. The polymer composition can be used to form an aqueous suspension. The material is ideally suited for use in preparing particleboard.

A method is disclosed for preparing such polylactic acid polymers. The method involves obtaining an amorphous polylactic acid polymer having a weight average molecular weight of between about 115,000 to about 180,000. Treating the polylactic acid polymer to reduce the molecular weight to between about 35,000 to 45,000 such that it has a glass transition temperature of between about 55° C. and 58° C. and a relative viscosity at 30° C. of about 1.65 to about 1.95 centipoise. Material can be formed into particles such that 90% of the particles have an average diameter of less than 250 μm.

The molecular weight of the polylactic acid polymer can be reduced by hydrolysis in a constant temperature water bath at about 92° C. for about 8.5 hours. Alternatively, the high molecular weight polymer can be processed thermally at a temperature of 255° C. for a sufficient time to obtain the desired molecular weight and viscosity in glass transition temperature. The molecular weight can also be reduced by treating material with radiation such as The method for preparing a polylactic acid polymer claim 4, wherein the treating step includes irradiation with a radiation source, including irradiation with Co⁶⁰ or with an eBeam.

### DETAILED DESCRIPTION OF INVENTION

The term “about” when used in conjunction with time means within 10%.

A polylactic acid polymer composition is disclosed. The polylactic acid polymer is amorphous and has a weight average molecular weight in the range of about 35,000 to 45,000. In an embodiment the material has a particle size sufficient to pass through a sieve having a pore size of about 250 μm or less. In an embodiment the polymer composition has a glass transition temperature of between about 55° C. to about 58° C. In an embodiment the material has a relative viscosity of the material at 30° C. of about 1.65 to about 1.95 centipoise.

The polylactic acid polymer can contain about 10 to about 15 mole percent D-lactide and can be prepared from an amorphous polylactic acid polymer having a higher molecular weight or can be synthesized by polymerizing lactic acid using well known means. For example, a commercial polylactic acid known as 10361D® can be purchased commercially from Natureworks. That polymer can then be made into a polymer having suitable characteristics for particle board manufacture by any suitable means. Amorphous polylactic acid polymers having a molecular weight in the range of about 115,000 to about 180,000 can also be used.

In one method the 10361D® polymer starting material can be suspended in water and heated at a constant temperature of about 92° C. for about 8.5 hours. Lower temperatures can be used for longer periods of time as desired. The material can then be dried by any suitable conventional means such as by heating in an oven and ground using to the desired particle size, such as by a hammer mill. The preparation of a material that can be sieved thru a 250 micron or smaller sieve provides for the preparation of stable aqueous suspensions that can be used interchangeably with current melamine or formaldehyde based adhesives used in current particle board manufacturing operations without clogging adhesive spray nozzles. The resulting particle board has water resistance characteristics and a suitable strength for widespread use in the particle board manufacturing industry.

Natureworks 10361D® polylactic acid can also be processed by heating to a constant temperature of about 255° C. for about 45 minutes. This heating process causes the polymer to melt. Therefore once the heating is discontinued processing the material to pass through a 250 micron mesh sieve is more difficult. This can be achieved by making pellets by extrusion processes or by cooling in a dimpled pan. Once the material is processed to a suitable form it can be ground to the desired size of 250 microns or less.

Natureworks 10361D® polylactic acid can also be processed using an irradiation process such as by treating the polymer with about 100 kGy of Co⁶⁰ gamma irradiation or about 200 kGy with an electron beam and then processed to particles that can pass through a 250 micron sieve or smaller.

The ground polylactic acid can then be used to prepare an aqueous suspension. Any concentration of polylactic acid can be used that can provide enough adhesive in the suspension for convenient use in particle board manufacture but which does not allow for particle agglomeration during storage. For example, about 10 wt. % to about 75 wt. % can be used, more preferably about 20 wt. % to about 55 wt. %, even more preferably about 25 wt. % to about 40 wt. % and generally a weight percent of about 33 to about 35 is envisioned.

A surfactant can be added to the water to help prevent particle agglomeration. For example, from about 0.3 wt. % to 10 wt. % of a surfactant can be added to the water followed by addition of the prepared polylactic acid polymer particles. The mixture can be mixed to form the suspension. A suspension made in this manner will remain a suspension for from several days to weeks without significant settling. In the event that settling does occur the suspension can be easily reformed by mixing.

The suspension made as described herein can be used in place of conventional formaldehyde and melamine adhesive preparations for the production of particle board without the need for significant changes to the equipment used for particle board manufacturing.

Particleboard or chipboard can be manufactured by mixing wood particles or flakes together with a resin and forming the mixture into a sheet. The raw material to be used for the particles can be prepared by any suitable means, such as by feeding it into a disc chipper with radially arranged blades. The particles are then dried, after which any oversized or undersized particles can be screened out.

An adhesive resin such as the suspension of polylactic acid polymer described herein is then sprayed through nozzles onto the particles.

Various other chemicals can also be added to the particle boards during manufacture including wax, dyes, wetting agents, release agents. These additives can be used to make the final product water resistant, fireproof, insect proof, or to give it another desirable quality.

Once the resin has been mixed with the particles, the liquid mixture is made into a sheet. A weighing device notes the weight of flakes, and they are distributed into position by rotating rakes. In graded-density particleboard, the flakes are spread by an air jet that throws finer particles further than coarse ones. Two such jets, reversed, allow the particles to build up from fine to coarse and back to fine.

The sheets formed are then cold-compressed to reduce their thickness and make them easier to transport. Later, they are compressed again, under pressures between 2 and 3 megapascals (290 and 440 psi). All aspects of this entire process must be carefully controlled to ensure the correct size, density and consistency of the board.

1. A polylactic acid polymer composition comprising an amorphous polylactic acid polymer having a weight average molecular weight in the range of about 35,000 to 45,000, wherein the material has a particle size sufficient to pass through a sieve having a pore size of about 250 μm or less, wherein the material has a glass transition temperature of between about 55° C. to about 58° C., and the relative viscosity of the material at 30° C. is about 1.65 to about 1.95 centipoise.

2. An aqueous suspension comprising the polylactic acid polymer composition of claim 1.

3. A particle board comprising the polylactic acid polymer composition of claim 1.

4. A method for preparing a polylactic acid polymer composition comprising obtaining an amorphous polylactic acid polymer having a weight average molecular weight of between about 115,000 to about 180,000; treating the polylactic acid polymer such that the molecular weight is between about 35,000 to 45,000, it has a glass transition temperature of between about 55° C. and 58° C., and it has a relative viscosity at 30° C. of about 1.65 to about 1.95 centipoise; forming particles from the treated polylactic acid polymer wherein 90% of the particles have an average diameter of less than 250 μm.

5. The method for preparing a polylactic acid polymer of claim 4, wherein the treating step includes hydrolysis in a constant temperature water bath at about 92° C. for about 8.5 hours.

6. The method for preparing a polylactic acid polymer of claim 4, wherein the treating step includes thermal processing and the constant temperature bath at about 255° C. for about 45 minutes.

7. The method for preparing a polylactic acid polymer claim 4, wherein the treating step includes irradiation with a radiation source.

8. The method for preparing a polylactic acid polymer of claim 4, wherein the treating step includes irradiation with Co⁶⁰.

9. The method for preparing a polylactic acid polymer claim 4, wherein the treating step includes irradiation with an eBeam.
